(19) United States
(12) Patent Application Publication
(10) Pub. No.: US 2012/0134265 A1
(43) Pub. Date: May 31, 2012

(54) TRAFFIC CONTROL SYSTEM FOR STEP-BY-STEP PERFORMING TRAFFIC CONTROL POLICIES, AND TRAFFIC CONTROL METHOD FOR THE SAME

(75) Inventors: Sang-Wan Kim, Daejeon-si (KR); Wang-Bong Lee, Daejeon-si (KR); Sang-Kil Park, Daejeon-si (KR)

(73) Assignee: ELECTRONICS AND TELECOMUNICATIONS RESEARCH INSTITUTE, Daejeon-si (KR)

(21) Appl. No.: 13/294,383

(22) Filed: Nov. 11, 2011

(30) Foreign Application Priority Data
Nov. 29, 2010 (KR) 10-2010-0119875

(51) Int. Cl. H04L 12/26

(52) U.S. Cl. 370/230

(57) ABSTRACT

Provided is a technique of step-by-step performing a plurality of traffic control policies by differentiating policies to be performed for each subscriber and establishing policy layers requiring a relatively long time to process traffic at later stages, thereby preventing a traffic control system from processing unnecessary traffic, reducing the load of the traffic control system upon processing traffic, and improving the performance of the traffic control system.

### CROSS-REFERENCE TO RELATED APPLICATION

This application claims the benefit under 35 U.S.C. §119(a) of a Korean Patent Application No. 10-2010-0119875, filed on Nov. 29, 2010, the entire disclosure of which is incorporated herein by reference for all purposes.

### BACKGROUND

1. Field

The following description relates to a traffic control system, and more particularly, to a technique for reducing the load of a traffic control system that has to process a large capacity of traffic on a high-speed line, through policy establishment by a policy server.

2. Description of the Related Art

With development of industry society, a vast amount of information is overcrowded and users' demands for quickly and accurately using various information are also increasing. In line with the demands, high-speed data transmission technologies have been developed to quickly and accurately exchange a large amount of information.

Recently, with help of development of circuit and component technologies, free frequency bands without requiring specific permissions, popularization of portable computers, etc., technologies for transmitting data at high speed under a mobile environment have been developed and used.

Among such high-speed data transmission technologies, a traffic control system for internet traffic control on a high-speed line basically requires high performance capable of processing a large capacity of traffic.

However, in order to process a large capacity of traffic on a high-speed line, a high-performance H/W processor for traffic control is also needed. However, such a high performance H/W processor increases the cost of the traffic control system.

For this reason, instead of using such a high-performance H/W processor, a technique for reducing the load of a traffic control system by allowing the traffic control system to define policies for processing traffic and perform the policies step-by-step is needed.

### SUMMARY

The following description relates to a traffic control system for performing policies that are step-by-step established by a policy server on a high-speed line.

The following description also relates to a technique of differentiating policies to be performed for each subscriber to provide policy layers requiring a relatively long time to process traffic at later stages.

The following description also relates to a technique for reducing the load of a traffic control system that has to process a large capacity of traffic.

In one general aspect, there is provided a traffic control method for step-by-step performing a plurality of traffic control policies in a traffic control system for processing traffic on a high-speed line, including: controlling a packet input to the traffic control system based on a filter policy, a system policy, a common service policy, and a subscriber policy, in this order, which are established by the traffic control system, according to characteristics of the packet.

The controlling of the packet includes filtering the packet input to the traffic control system according to the filter policy based on a Virtual LAN (VLAN), an IP version, and a protocol type.

The controlling of the packet includes controlling the packet input to the traffic control system based on the system policy based on a user's reliability and the amount of traffic.

The controlling of the packet includes: determining reliability of a user that has requested or transmitted the packet, and allowing the packet if it is determined that the user is trusted; and allowing the packet if a current amount of traffic is less than a threshold amount allowable by the traffic control system.

The controlling of the packet includes controlling all packets input to the traffic control system according to the common service policy that is established according to a use purpose of the traffic control system.

The controlling of the packet includes controlling the packet input to the traffic control system according to the subscriber policy that is established for each subscriber by the traffic control system.

In another general aspect, there is provided a traffic control system for step-by-step performing a plurality of traffic control policies to process traffic on a high-speed line, including: a filter policy performing unit to filter a packet input to the traffic control system according to a filter policy based on a Virtual LAN (VLAN), an IP version, and a protocol type; a system policy performing unit to control the filtered packet according to a system policy based on a user's reliability and the amount of traffic; a service policy performing unit to control all packets input to the traffic control system according to a common service policy that is established according to a use purpose of the traffic control system; and a subscriber policy performing unit to control the packet according to a subscriber policy that is established for each subscriber by the traffic control system.

The system policy performing unit includes: a user policy performing unit to determine reliability of a user that has requested or transmitted the packet, and to allow the packet if it is determined that the user is trusted; and a status policy performing unit to allow the packet if a current amount of traffic is less than a threshold amount allowable by the traffic control system.

Each of the service policy performing unit and the subscriber policy performing unit includes: a unit policy storage to store one or more unit policies for controlling packets based on IP addresses, ports, and signatures; and a policy group storage to group the stored unit policies to one or more logical groups, to store the logical groups, and to create and manage all policies that are performed by the traffic control system.

The packet input to the traffic control system sequentially passes through the filter policy performing unit, the system policy performing unit, the service policy performing unit, and the subscriber policy performing unit.

Therefore, by step-by-step establishing policies, it is possible to in advance prevent a traffic control system from processing unnecessary traffic.

Also, by differentiating policies to be performed for each subscriber and establishing policy layers requiring a relatively long time to process traffic at later stages, it is possible to reduce the load of the traffic control system upon processing traffic and accordingly improve the performance of the traffic control system.

Other features and aspects will be apparent from the following detailed description, the drawings, and the claims.

### BRIEF DESCRIPTION OF THE DRAWINGS

FIG. 1 is a diagram illustrating an example of a logical hierarchical structure for establishing policies in a traffic control system.

FIG. 2 is a diagram illustrating an example of a traffic control system.

FIG. 3 is a view for explaining a method of controlling traffic according to policies of the traffic control system illustrated in FIG. 2.

FIG. 4 is a flowchart illustrating another method I of controlling traffic according to policies of the traffic control system illustrated in FIG. 2.

FIG. 5 is a flowchart illustrating another method II of controlling traffic according to policies of the traffic control system illustrated in FIG. 2.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. Also, descriptions of well-known functions and constructions may be omitted for increased clarity and conciseness.

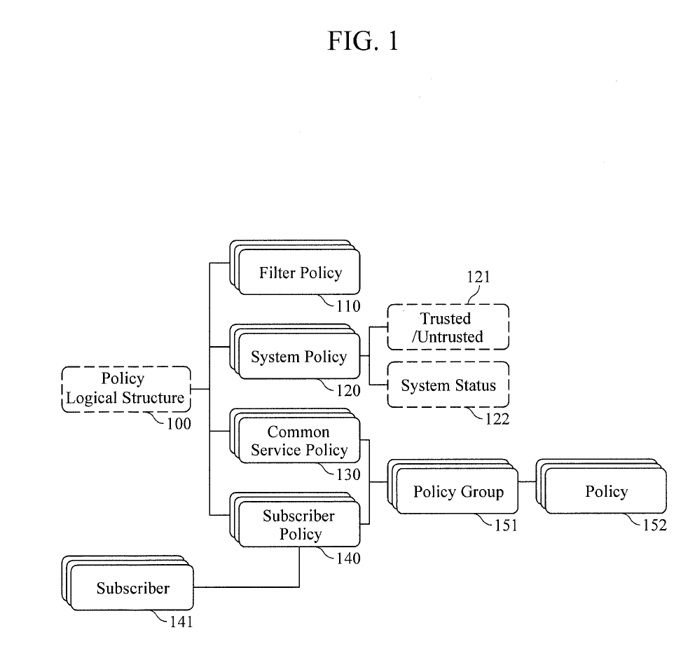

FIG. 1 is a diagram illustrating an example of a logical hierarchical structure for establishing policies in a traffic control system.

Referring to FIG. 1, a policy logical structure 100, which can be established by the traffic control system, logically has 6 policy layers: a filter policy 110, a system policy 120, a common service policy 130, a subscriber policy 140, a policy group 151, and a policy 152. The filter policy 110 is a filtering policy based on a Virtual LAN (VLAN), an IP version, a protocol type, etc. to determine whether to process a received packet. Traffic filtered according to the filter policy 110 is filtered in/allowed to the next stage or filtered out/dropped from the next stage.

The system policy 120 is a policy corresponding to content that can establish a policy in view of system, and may be composed of a trusted user policy 121 and a system status policy 122.

The received packet is allowed or dropped according to whether a user who has requested or transmitted the packet is “trusted” or “untrusted”, which is determined from the policy content established in the trusted user policy 121.

The system status policy 122 is a system policy for allowing packets if a current amount of traffic is less than a threshold amount allowable by the system or for controlling the flow of packets based on statistical information about input packets. The system status policy 122 may control the amount of traffic that is input to the traffic control system when a large amount of traffic such as abnormal traffic is generated in a short time.

The policy 152 provides a basic unit policy for controlling packets based on IP addresses, ports, signatures, etc.

The policy group 151, which is a logical group of policies, functions to easily manage the policies, for example, in such a manner as to group predefined policies to create a single policy.

The common service policy 130, which is a logical group of policy groups, functions to easily manage predefined policy groups.

The common service policy 130 may establish a policy that can be applied in common to all input traffic regardless of individual subscribers or systems.

For example, in the case of a traffic control system for a college campus, a policy establisher can establish a policy for blocking all P2P traffic, and in this case, the common service policy 130 may define a policy that is to be applied to all P2P traffic that is input to the traffic control system.

The subscriber policy 140, which is another logical group of policy groups, functions to easily manage predefined policy groups. The subscriber policy 140 is applied only to specific subscribers 141.

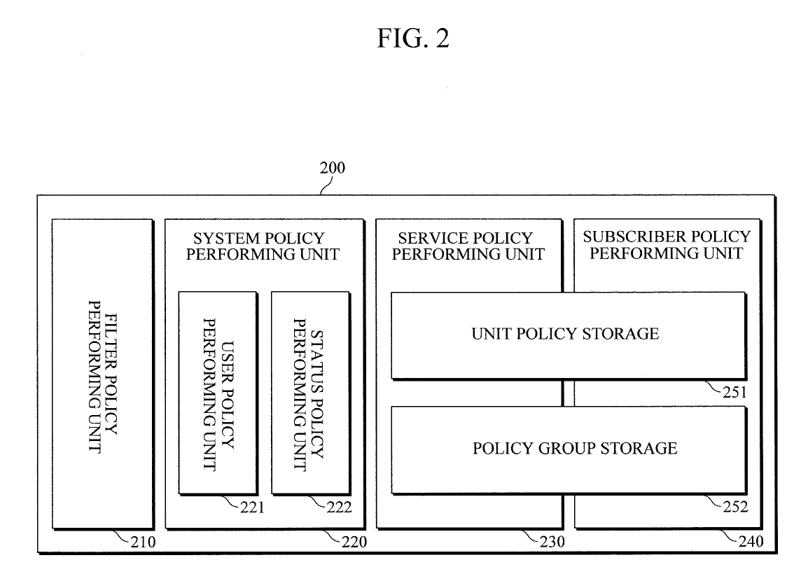

FIG. 2 is a diagram illustrating an example of a traffic control system 200. Referring to FIG. 2, the traffic control system 200 may include a filter policy performing unit 210, a system to policy performing unit 220, a service policy performing unit 230, and a subscriber policy performing unit 240.

The filter policy performing unit 210 filters a packet input to the traffic control system 200 according to the filter policy based on a Virtual LAN (VLAN), an IP version, a protocol type, etc. of the packet.

The system policy performing unit 220 may include a user policy performing unit 221 and a status policy performing unit 222, and control the filtered packet according to the system policy based on a user's reliability and the amount of traffic.

The user policy performing unit 221 determines whether or not a user who has requested or transmitted the packet is “trusted”, and allows, if the user is “trusted”, the corresponding packet.

The status policy performing unit 222 determines whether a current amount of traffic is less than a threshold amount allowable by the traffic control system and allows the corresponding packet if the current amount of traffic is less than the threshold amount.

The service policy performing unit 230 controls all received packets according to the common service policy that is established according to a use purpose of the traffic control system 200.

The subscriber policy performing unit 240 controls the received packet according to the subscriber policy that is established for each subscriber by the traffic control system 200.

The service policy performing unit 230 and the subscriber policy performing unit 240 may share a unit policy storage 251 and a policy group storage 252. Or, the service policy performing unit 230 and the subscriber policy performing unit 240 may each include the unit policy storage 251 and the policy group storage 252.

The unit policy storage 251 controls the received packet based on the IP address, port, and signature of the packet, and the policy group storage 252 groups unit policies stored therein into a logical group, stores the logical group, and creates and manages all policies that are performed on the traffic control system 200.

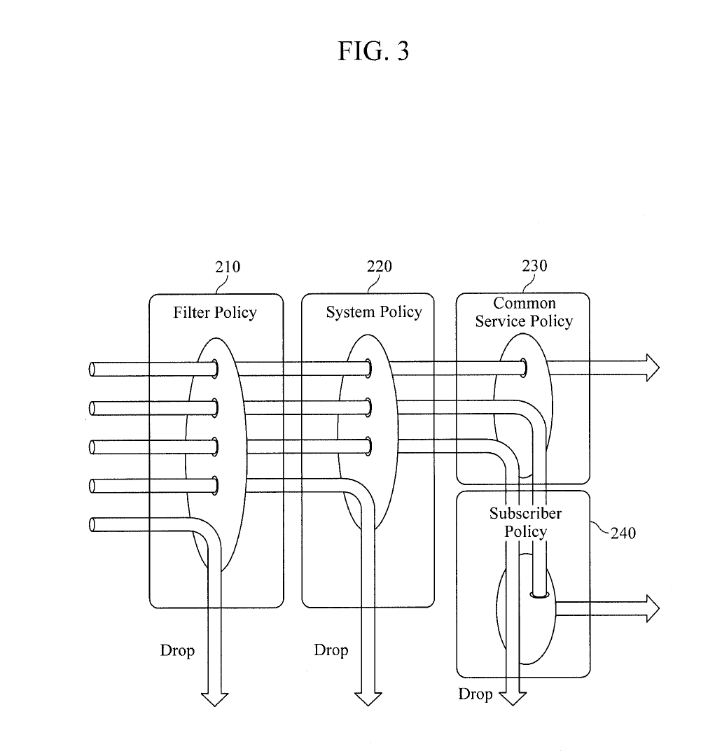

FIG. 3 is a view for explaining a method of controlling traffic according to policies of the traffic control system 200. FIG. 3 relates to a procedure for reducing the load of the traffic control system 200 by step-by-step applying logically classified policies.

Referring to FIGS. 2 and 3, when a packet is input to the traffic control system 200, first, the filter policy performing unit 210 applies the filter policy to the packet to filter (drop) any unnecessary packet.

The packet that has passed through the filter policy performing unit 210 is input to the system policy performing unit 220, and the system policy performing unit 220 drops a untrusted packet (that is, a packet transmitted from an untrusted user) having a disallowable IP address or determines whether a current amount of traffic is more than a threshold amount and drops the corresponding packet if the current amount of traffic is more than the threshold amount. That is, the system policy performing unit 220 drops packets exceeding an allowable amount of traffic, expressed in unit of bps, pps, fps, etc., thereby adjusting the bandwidth of input traffic.

The packet that has passed through the system policy performing unit 220 is input to the common service policy performing unit 230, and the common service policy performing unit 230 processes, if the packet satisfies the common service policy that is applied to all input traffic, the packet according to a policy established by a policy establisher.

The common service policy performing unit 230 processes packets in advance according to a policy that is applied in common to all packets, thereby reducing traffic load that has to be processed by the subscriber policy performing unit 240 for performing a policy for each specific subscriber.

Finally, the packet dropped by the common service policy performing unit 230 is input to the subscriber policy performing unit 240, and the subscriber policy performing unit 240 determines whether there is a subscriber policy which the packet satisfies. If there is a subscriber policy which the packet satisfies, the subscriber policy performing unit 240 controls the packet according to the subscriber policy, and if there is no subscriber policy which the packet satisfies, the subscriber policy performing unit 240 drops the packet.

Since packets allowed at the earlier stages through step-by-step policy rules are not subject to policy processing at the later stages, the traffic control load of the traffic control system 200 may be reduced, which leads to improvement of system performance.

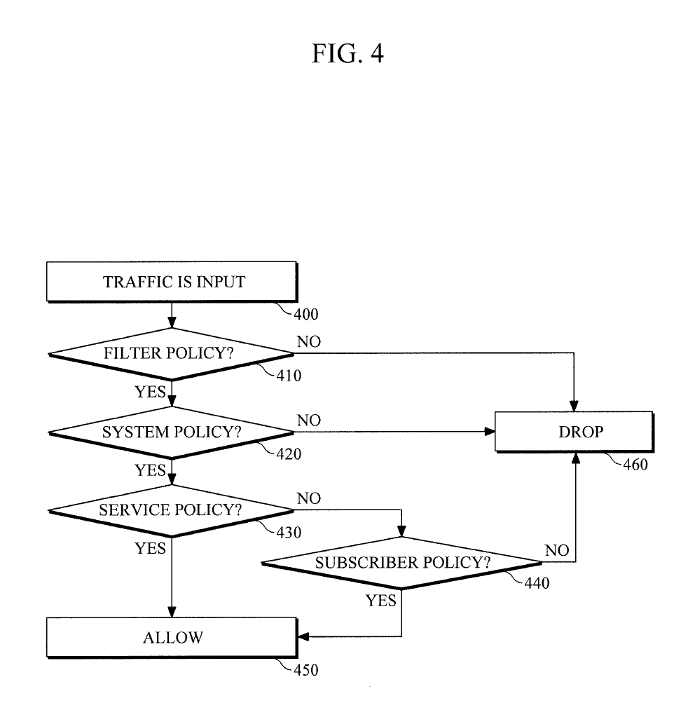

FIG. 4 is a flowchart illustrating another method I of controlling traffic according to a policy of the traffic control system 200 illustrated in FIG. 2.

Referring to FIG. 4, a method of controlling packets sequentially according to the filter policy, the system policy, the common service policy, and the subscriber policy, which are basically set by the traffic control system 200, will be described.

First, when a packet is input to the traffic control system (400), the packet is filtered according to the filter policy based on a VLAN, an IP version, and a protocol type of the packet (410). If the packet does not satisfy the filter policy, the packet is dropped (460).

The packet allowed according to the filter policy is controlled according to the system policy based on a user's reliability and the amount of traffic (420). If the packet does not satisfy the system policy, the packet is also dropped (460).

All packets allowed in operation 420 are controlled according to the common service policy that is established according to a user purpose of the traffic control system 200 (430). Packets which satisfy the common service policy are finally allowed as packets which satisfy all policies of the traffic control system 200 (450).

If a packet satisfies the subscriber policy that is established for each subscriber by the traffic control system 200 although the packet does not satisfy the common service policy (440), the corresponding packet is allowed (450), and if the packet does not satisfy the subscriber policy, the packet is finally dropped (460).

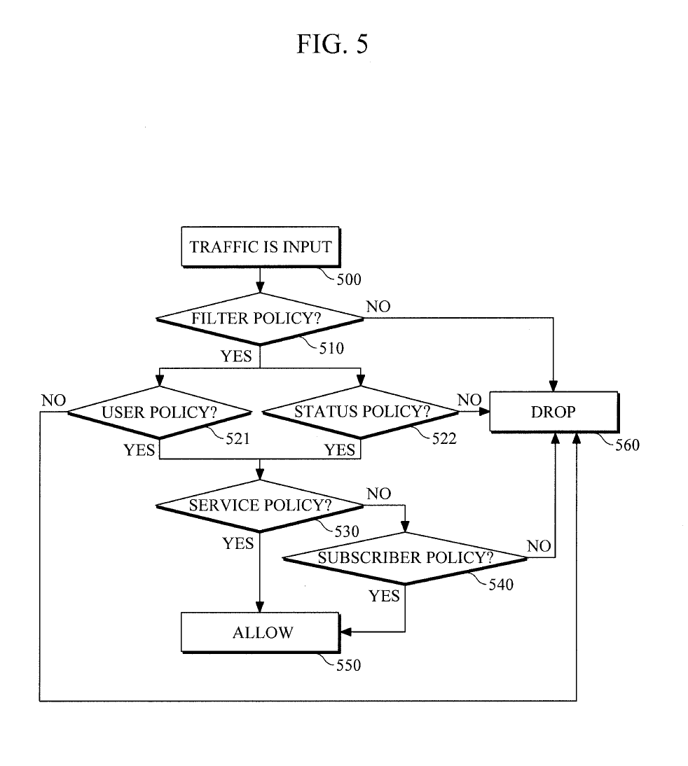

FIG. 5 is a flowchart illustrating another method II of controlling traffic according to a policy established by the traffic control system 200 illustrated in FIG. 2.

Referring to FIG. 5, the method II of controlling traffic follows the same procedure as the method I described above with reference to FIG. 4, except that the system policy included in the method I is divided to a user policy and a status policy.

First, when a packet is input to the traffic control system 200 (500), the packet is filtered according to the filter policy based on a VLAN, an IP version, and a protocol type of the packet (510). If the packet does not satisfy the filter policy, the packet is dropped (560).

Then, it is determined whether the packet allowed in operation 510 is “trusted” based on reliability of a user who has requested or transmitted the packet, and if the user is “trusted”, the packet is allowed (521). Also, it is determined whether a current amount of traffic is less than a threshold amount allowable by the traffic control system 200 (522). If the current amount of traffic does not exceed the threshold amount, the corresponding packet is also allowed.

In operations 521 and 522, it may be determined whether the packet satisfies the user policy and whether the packet satisfies the status policy, individually. However, it is also possible that only the packet which satisfies both the user policy and the status policy is allowed.

In the current example, if the packet does not satisfy either the user policy or the status policy, the corresponding packet is dropped (560).

All packets allowed in operations 521 and 522 are controlled according to the common service policy that is established according to a use purpose of the traffic control system 200 (530). Packets that satisfy the common service policy are finally allowed as packets that satisfy all policies of the traffic control system 200 (550).

If a packet does not satisfy the common service policy while satisfying the subscriber policy that is established for each subscriber by the traffic control system 200 (540), the packet is allowed (550), and if the packet does not satisfy the subscriber policy, the packet is finally dropped (560).

The present invention can be implemented as computer readable codes in a computer readable record medium. The computer readable record medium includes all types of record media in which computer readable data are stored. Examples of the computer readable record medium include a ROM, a RAM, a CD-ROM, a magnetic tape, a floppy disk, and an optical data storage. Further, the record medium may be implemented in the form of a carrier wave such as Internet transmission. In addition, the computer readable record medium may be distributed to computer systems over a network, in which computer readable codes may be stored and executed in a distributed manner.

A number of examples have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A traffic control method for step-by-step performing a plurality of traffic control policies in a traffic control system for processing traffic on a high-speed line, comprising:
controlling a packet input to the traffic control system based on a filter policy, a system policy, a common service policy, and a subscriber policy, in this order, which are established by the traffic control system, according to characteristics of the packet.

2. The traffic control method of claim 1, wherein the controlling of the packet comprises filtering the packet input to the traffic control system according to the filter policy based on a Virtual LAN (VLAN), an IP version, and a protocol type.

3. The traffic control method of claim 1, wherein the controlling of the packet comprises controlling the packet input to the traffic control system based on the system policy based on a user's reliability and the amount of traffic.

4. The traffic control method of claim 1, wherein the controlling of the packet comprises:
determining reliability of a user that has requested or transmitted the packet, and allowing the packet if it is determined that the user is trusted; and
allowing the packet if a current amount of traffic is less than a threshold amount allowable by the traffic control system.

5. The traffic control method of claim 1, wherein the controlling of the packet comprises controlling all packets input to the traffic control system according to the common service policy that is established according to a use purpose of the traffic control system.

6. The traffic control method of claim 1, wherein the controlling of the packet comprises controlling the packet input to the traffic control system according to the subscriber policy that is established for each subscriber by the traffic control system.

7. A traffic control method which is performed by a traffic control system for processing traffic on a high-speed line, comprising:
filtering a packet input to the traffic control system according to a filter policy based on a Virtual LAN (VLAN), an IP version, and a protocol type;
controlling the filtered packet according to a system policy based on a user's reliability and the amount of traffic;
is controlling all packets input to the traffic control system according to a common service policy that is established according to a use purpose of the traffic control system; and
controlling the packet according to a subscriber policy that is established for each subscriber by the traffic control system.

8. The traffic control method of claim 7, wherein the packet is sequentially controlled according to the filter policy, the system policy, the common service policy, and the subscriber policy, which are established by the traffic control system.

9. The traffic control method of claim 7, wherein the controlling of the packet according to the system policy comprises:
determining reliability of a user that has requested or transmitted the packet, and allowing the packet if the user is trusted; and
allowing the packet if a current amount of traffic is less than a threshold amount allowable by the traffic control system.

10. A traffic control system for step-by-step performing a plurality of traffic control policies to process traffic on a high-speed line, comprising:
a filter policy performing unit to filter a packet input to the traffic control system according to a filter policy based on a Virtual LAN (VLAN), an IP version, and a protocol type;
a system policy performing unit to control the filtered packet according to a system policy based on a user's reliability and the amount of traffic;
a service policy performing unit to control all packets input to the traffic control system according to a common service policy that is established according to a use purpose of the traffic control system; and
a subscriber policy performing unit to control the packet according to a subscriber policy that is established for each subscriber by the traffic control system.

11. The traffic control system of claim 10, wherein the system policy performing unit comprises:
a user policy performing unit to determine reliability of a user that has requested or transmitted the packet, and to allow the packet if it is determined that the user is trusted; and
a status policy performing unit to allow the packet if a current amount of traffic is less than a threshold amount allowable by the traffic control system.

12. The traffic control system of claim 10, wherein each of the service policy performing unit and the subscriber policy performing unit comprises:
a unit policy storage to store one or more unit policies for controlling packets based on IP addresses, ports, and signatures; and
a policy group storage to group the stored unit policies to one or more logical groups, to store the logical groups, and to create and manage all policies that are performed by the traffic control system.

13. The traffic control system of claim 10, wherein the packet input to the traffic control system sequentially passes through the filter policy performing unit, the system policy performing unit, the service policy performing unit, and the subscriber policy performing unit.
